(19) United States
(12) Patent Application Publication
(10) Pub. No.: US 2003/0159105 A1
(43) Pub. Date: Aug. 21, 2003

(54) Interpretive transformation system and method

(76) Inventor: Steven P. Hiebert, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/080,972

(22) Filed: Feb. 21, 2002

(51) Int. Cl. G06F 15/00

(52) U.S. Cl. 715/500

(57) ABSTRACT

Various systems, methods, and programs stored in a computer-readable medium to perform a transformation are provided. In one embodiment, a transformation method is provided that comprises the steps of providing a transformation processor, providing a prototype transform and an interpretive transform, and, transforming at least one source document into an output document with the transformation processor by interpreting a number of interpreted instructions in the prototype transform with a number of interpretive instructions from the interpretive transform.

### TECHNICAL FIELD

The present invention is generally related to the field of data processing and, more particularly, is related to a system and method for transformation of files using interpretation.

### BACKGROUND

In various fields, data in digital form such as text, photos, articles, graphics and other items may be exchanged in various formats over the Internet and through other services. In order to facilitate the exchange of such data, standardized formats are often employed between transmitting and receiving parties. However, due to a lack of adherence to established standards or in some cases due to a lack of standards to begin with, various data may be transmitted in many different formats. In order to properly receive and handle such data, the receiving party might employ transformation processors and the like to transform the data embodied in varying formats into an acceptable standard format compatible with the receiving party's systems. Unfortunately, this may result in a significant amount of coding and time in order to implement the appropriate transformation of a variety of data formats.

To provide a single example of the foregoing, in the publishing field, content items in digital form such as news, features, photos, articles, graphics and other items are available for publishing via the Internet and through other services. For example, such content items may be obtained from the Associated Press or other news organizations. Also, many newspapers are becoming national in scope exporting their content to individuals all over the United States via the Internet or other networks.

In order to facilitate transmission of news articles over the Internet and other networks, news publishers have adopted a special standard format to be employed for news articles. This format is called the News Industry Text Format (NITF). The NITF provides a solution for sharing news developed by the world's leading news publishers. NITF uses the Extensible Markup Language (XML) to define the content and structure of news articles using metadata. Because metadata is applied throughout the news content, NITF documents are far more searchable and useful than web pages written in Hypertext Markup Language (HTML) or regular text formats.

By using NITF, publishers can adapt the look, feel, and interactivity of their documents to the bandwidth, devices, and personalized needs of their subscribers. These documents can be translated into HTML, WML (for wireless devices), RTF (for printing), or any other format the publisher wishes. NITF was developed by the International Press Telecommunications Council, an independent international consortium of the world's leading news agencies and publishers. It is a standard that is open, public, proven, well used, well documented, and well supported.

Unfortunately, much of the available content in digital format is not composed using the NITF standard. For example, many news articles are made available in text format or other formats. As a consequence, applications that require articles and the like to conform with NITF cannot process such articles. Consequently, for each different format, a transformation is necessary in order to embody respective content items into the desired NITF format. Also, if one wishes to embody such content items into formats that differ from the NITF format, then different transformations would be necessary. In order to perform these multiple transformations, significant effort and resources are necessary to generate the corresponding transformation code, etc. As a result, the effective transformation of data is impeded accordingly.

### SUMMARY

In light of the forgoing, the present invention provides for various systems, methods, and programs stored in a computer-readable medium to perform a transformation. In one embodiment, a transformation method is provided that comprises the steps of providing a transformation processor, providing a prototype transform and an interpretive transform, and, transforming at least one source document into an output document with the transformation processor by interpreting a number of interpreted instructions in the prototype transform with a number of interpretive instructions from the interpretive transform.

In another embodiment, the present invention provides for a computer program embodied in a computer readable medium to perform a transformation.

The computer program comprises an interpretive transform, a prototype transform to be interpreted using the interpretive transform, at least one source document associated with the prototype transform, and a transformation processor. The program further comprises code that initiates a transformation of the source document into an output document with the transformation processor, the transformation processor interpreting a number of interpreted instructions in the prototype transform with a number of interpretive instructions from the interpretive transform.

In still another embodiment, the present invention provides for a transformation system that comprises a processor circuit having a processor and a memory. Stored in the memory and executable by the processor is transformation logic that comprises an interpretive transform, a prototype transform to be interpreted using the interpretive transform, a transformation processor, and, logic that initiates a transformation of at least one source document into an output document with the transformation processor, the transformation processor interpreting a number of interpreted instructions in the prototype transform with a number of interpretive instructions from the interpretive transform, wherein an association is drawn between the at least one source document and the prototype transform.

Other embodiments and aspects of the present invention will become apparent to a person with ordinary skill in the art in view of the following drawings and detailed description. It is intended that all such additional embodiments and aspects be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a drawing of a computer system that performs an interpretive transformation according to an aspect of the present invention;

FIG. 2 is a functional block diagram of the interpretive transformation of FIG. 1;

FIG. 3 is a drawing of a source document according to an aspect of the present invention;

FIG. 4 is a drawing of an output document generated from the source document implementing the interpretive transformation of FIG. 2; and

FIG. 5 is a flow chart of transformation logic implemented in the computer system of FIG. 1 to generate the output document from the source document.

### DETAILED DESCRIPTION

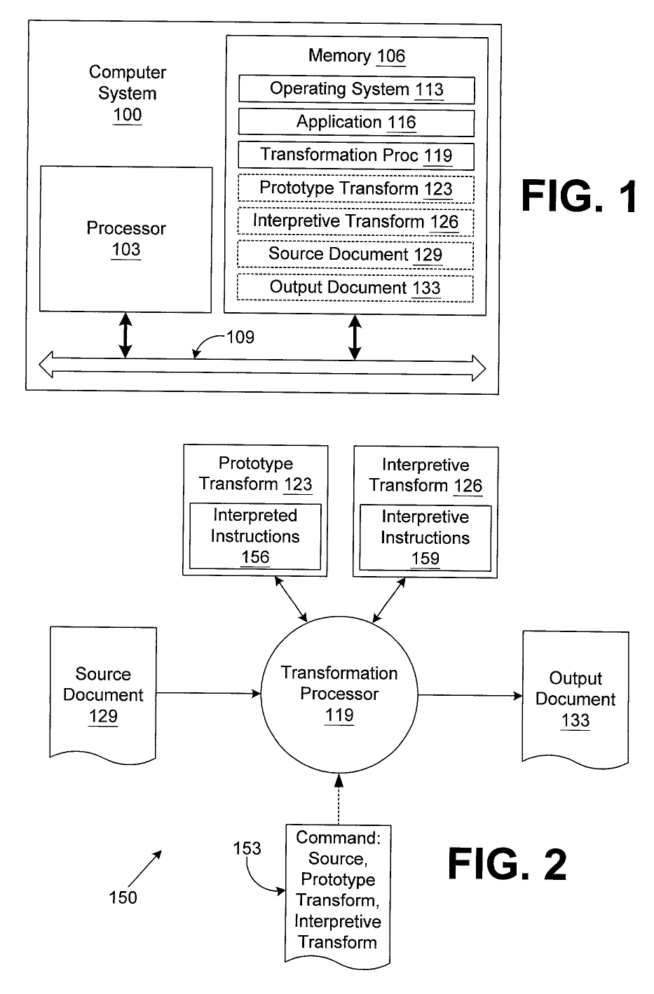

With reference to FIG. 1, shown is a computer system 100 according to an aspect of the present invention. The computer system 100 includes a processor circuit having a processor 103 and a memory 106, both of which are coupled to a local interface 109. The local interface 109 may be, for example, a data bus with an accompanying control/address bus as can be appreciated by those with ordinary skill in the art. In this respect, the computer system 100 may be, for example, a general computer system or other device with like capability.

Stored in the memory 106 and executable by the processor 103 are an operating system 113, an application 116, and a transformation processor 119. The transformation processor 119 may be, for example, an Extensible Stylesheet Language Transform (XSLT) processor or equivalents thereof. A detailed specification of an XSLT processor is set forth in the XSL transformations “XSLT”, version 1.0, W3C Recommendation, Nov. 16, 1999, the entire content of which is incorporated herein by reference. Also stored on the memory 106 and accessible by the processor 103 are a prototype transform 123, an interpretive transform 126, a source document 129, and an output document 133. According to the present invention, the transformation processor 119 is employed to transform the source document 129 into the output document 133 by processing the prototype transform 123 that is interpreted in light of the interpretive transform 126 as will be discussed.

The computer system 100 may also include various peripheral devices such as, for example, a keyboard, keypad, touch pad, touch screen, microphone, scanner, mouse, joystick, or one or more push buttons, etc. The peripheral devices may also include display devices, indicator lights, speakers, printers, etc. Specific display devices may be, for example, cathode ray tubes (CRTs), liquid crystal display screens, gas plasma-based flat panel displays, or other types of display devices, etc.

Also, the memory 106 is defined herein as both volatile and nonvolatile memory and data storage components. Volatile components are those that do not retain data values upon loss of power. Nonvolatile components are those that retain data upon a loss of power. Thus, the memory 106 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 103 may represent multiple processors and the memory 106 may represent multiple memories that operate in parallel. In such a case, the local interface 109 may be an appropriate network that facilitates communication between any two of the multiple processors, between any processor and any one of the memories, or between any two of the memories etc. The processor 103 may be electrical or optical in nature.

The operating system 113 is executed to control the allocation and usage of hardware resources in the computer system 100 such as the memory, processing time and peripheral devices. In this manner, the operating system 113 serves as the foundation on which applications depend as is generally known by those with ordinary skill in the art.

With reference then to FIG. 2, shown is block diagram of a transformation operation 150 according to an aspect of the present invention. The transformation operation 150 begins by the application of a transformation command 153 to the transformation processor 119. The transformation command 153 directs the transformation processor 119 to perform the transformation operation 150 in which the source document 129 is transformed into the output document 133. The source document 129 and the output document 133 may be created using, for example, an extensible markup language (XML) or equivalent markup language as can be appreciated by those with ordinary skill in the art. In the case that the transformation processor 119 operates according to the dictates of the XSL transformations recommendation identified above, the source document 129 and the output document 133 are typically XML documents.

The transformation command 153 applied to the transformation processor 119 includes a reference to the prototype transform 123, the interpretive transform 126, and the source document 129. In this respect, the transformation command 153 associates the prototype transform 123, the interpretative transform 126, and the source document 129 with each other. This is done so that the transformation processor 119 can access and process the proper prototype transform 123, interpretive transform 126, and the source document 129 assuming that different transforms 123/126 and source documents 129 are stored or otherwise located in the memory 106.

The transformation command 153 is generated, for example, by the application 116 that controls when the source document 129 is transformed into the output document 133. The application 116 may encompass any particular application that requires such a transformation.

When the transformation command 153 is applied to the transformation processor 119, the transformation processor 119 proceeds to transform the source document 129 into the output document 133. In order to accomplish such a transformation, the transformation processor 119 processes the prototype transform 123. To explain further, the prototype transform 123 includes a number of interpreted instructions 156 that are “transformation specific” in that they relate to the specific transformation necessary to convert to the source document 129 into the output document 133. The prototype transform 123 conforms to the dictates of XML in that it is “well-formed”, etc., as can be appreciated by those with ordinary skill in the art.

The interpreted instructions 156 in the prototype transform 123 are “transformation specific” in that they provide specific instructions to the transformation processor 119 in processing the source document 129 into the output document 133. That is to say that the interpreted instructions 156 relate specifically to the transformation to be performed. To begin a specific transformation, the transformation processor 119 identifies elements in the interpreted instructions 156 that require processing. For each item or element in the interpreted instructions 156, the transformation processor 119 applies the interpretive transform 126 to determine what steps are to be taken in interpreting the particular element of the interpreted instructions 156. In this regard, the interpretative transform 126 includes interpretive instructions 159 that are executed in processing a respective interpreted instruction 156.

Not all of the interpretive instructions 159 relate to every statement and/or element in the interpreted instructions 156. Thus, the transformation processor 119 compares the interpretive instructions 159 with the respective element or statement identified in the interpreted instructions 156 to determine which interpretive instructions 159 are to be processed in light of the respective interpreted instruction 156. In this respect, the interpretive instructions 159 may include a number of templates as is set forth in the XSL Transformations recommendation referenced above.

Preferably, the transformation processor 119 processes the interpreted instructions 156 interpreting them with the interpretive instructions 159 to perform the transformation of the source document 129 into the output document 133. The interpretive instructions 159 of the interpretive transform 126 are “transformation generic” in that many different prototype transforms 123 may be interpreted thereby to perform respective different transformations of respective source documents 129 into corresponding output documents 133. This provides a significant advantage in that the interpreted instructions 156 and interpretive instructions 159 are not combined into a single large transform that would require significant revision in order to perform a transformation that such a document originally was not designed to perform. In the case of the transformation operation 150, in order to perform a new transformation operation, the user need only create a new prototype transform 123 that specifically addresses the transformation to be performed. Thus, the prototype transform 123 is labeled “prototype” because in a sense it ultimately provides a prototype for the transformation to be performed.

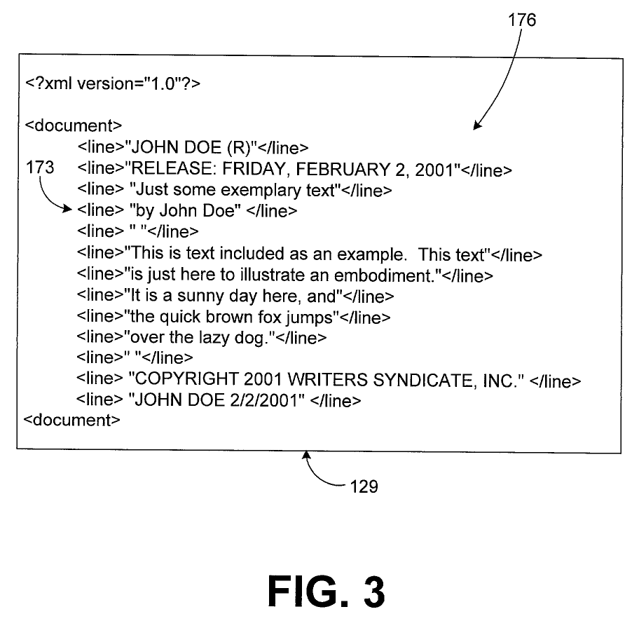

With reference to FIG. 3, shown is an example of the source document 129 according to an embodiment of present invention. The source document 129 includes a number of indiscriminate line tags 173 that mark the number of lines of content 176 for a hypothetical article that may be printed in a publication, such as, for example, a magazine or newspaper. The source document 129 includes various content 176 such as, a title, author, copyright date, release date, and body of the article itself. A further discussion of this exemplary source document 129 is provided with reference to co-pending U.S. patent application entitled System and Method for Formatting Publishing Content, filed on Jul. 25, 2001 and accorded Ser. No. 09/915,975. In particular, the source document 129 represents an article that was originally embodied as a text file or similar format that was converted into Extensible Markup Language (XML) with indiscriminate line tags 173. For various reasons, the first document 129 may need to be transformed into an output document 133 based upon a particular application or other considerations that require the various elements of the content 176 to be tagged, reordered, or otherwise organized in the output document 133.

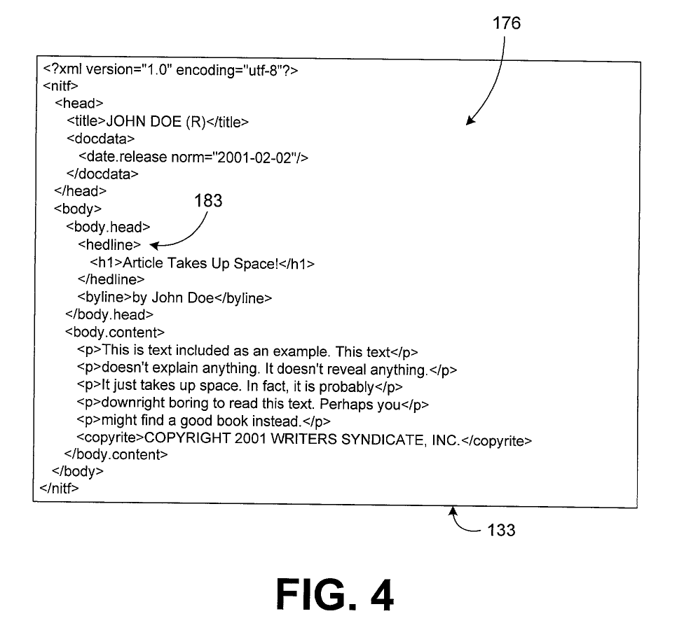

Referring next to FIG. 4, shown is an example of the output document 133 according to an aspect of the present invention. The output document 133 results from a transformation performed upon the source document 129 (FIG. 3) to place the content 176 contained therein into a desired format. In the example of FIG. 4, the article depicted in the source document 129 of FIG. 3 has been transformed into a News Industry Text Format (NITF) that is set forth by the publishing industry as can be appreciated by those with ordinary skill in the art. However, it is understood that the source document 129 of FIG. 3 and the output document 133 of FIG. 4 are employed herein merely to provide an example of a transformation using interpretation as is described herein in detail. Specifically, the substance and form of the content 176 of the source document 129 and the output document 133 is of no consequence.

It is also understood that there are many other different types of transformations that could be performed on an unlimited variety of source documents 129 to generate a corresponding unlimited variety of output documents 133. As depicted in the source document 133, for example, a number of elements 183 are identified with tags according to a predefined data type description (DTD) that is specified in the NITF standard. The order of the various elements of the source document 129 differs from the order of the same elements in the output document 133. Also, in the output document 133, various elements of the content 176 are associated with various tags and attributes, etc., that are not included in the source document 129. According to an aspect of the present invention, various documents 129 are transformed into output document 133 by a specific transformation that is identified in the prototype transform 123.

In addition to the exemplary source document 129 of FIG. 3 and the exemplary output document 133 of FIG. 4, examples of the prototype transform 123 and the interpretive transform 126 are included in Appendix I and Appendix 11, respectively, that are employed to transform the exemplary source document 129 (FIG. 3) into the exemplary output document 133 (FIG. 4).

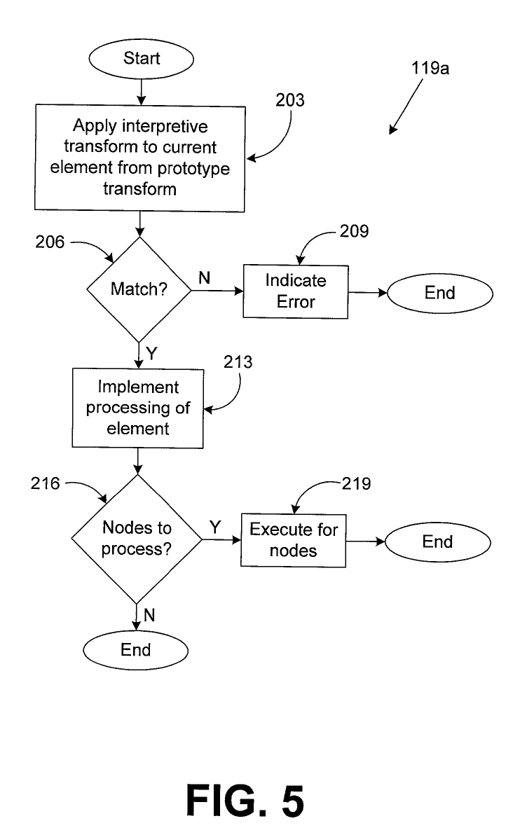

Turning then to FIG. 5, shown is a flowchart of a recursive routine 119a that is implemented as a portion of the transformation processor 119 in performing the transformation of the source document 129 (FIG. 2) into the output document 133 (FIG. 2). Alternatively, the flowchart of FIG. 5 may be viewed as depicting steps in a method implemented in the computer system 100 to perform the same transformation. The recursive routine 119a may represent only a portion of the full functionality of the transformation processor 119, as can be appreciated by those with ordinary skill in the art. Also, it is understood that the functionality of the recursive routine 119a may be implemented in terms of non-recursive code as can be appreciated by those with ordinary skill in the art.

Upon being implemented by receipt of the transformation command 153 (FIG. 1), the recursive routine 119a is executed beginning with box 203 in which the prototype transform 123 (FIG. 2) identified in the transformation command 153 (FIG. 2) is applied to a current node identified in the prototype transform 123 for interpretation. In so, applying the interpretive transform, the current node or element of the prototype transform 123 is compared with a number of templates in the prototype transform 123 to identify a match there between.

In box 206, if a match is not found, then the recursive routine 119a proceeds to box 209 to indicate an error to the user in an appropriate manner as a match was not found in order to properly interpret the current elements from the prototype transform 123. The error may be indicated to the user in a number of different ways, such as, for example, by display on a display device or the error may be written to a log, etc. Thereafter, the recursive routine 119a ends. On the other hand, assuming that a match is found in box 206, then the recursive routine 119a proceeds to box 213.

In box 213, the current node or element from the prototype transform 123 is interpreted using the interpretive transform 126. Specifically, the template that contains the interpretive instructions relative to the current node or element from the prototype transform 123, is implemented by the transformation processor 119 to generate an appropriate portion of the output document 133 therefrom. Specifically, with regard to the exemplary source and output documents 129 and 133, the interpretive transform 123 provides functionality dedicated to the process of extracting lines and processing them to create the output file 133.

In this regard, there may be a number of different types of interpretive tasks that are performed in interpreting nodes or elements from the prototype transform 123 in box 213. For example, a direct transformation may occur in which an element is taken directly from the prototype transform 123 that may or may not be altered and then written directly to the output document 133. In another example, attributes that are indicated in a respective template in the interpretive instructions 150 may be written to the output document 133 relative to the current node of the prototype transform 123. Also, the interpretive instructions 159 may include instructions that locate one or more lines or ranges of lines in the source document 129 as well as instructions for processing the text of lines and ranges of lines to create the output document 133. Thus, the actual elements in the output document 133 may be created from the literal instructions in the interpreted prototype transform 126 with textual content from the source document 129.

The instructions to locate a line or range of lines in the interpretive instructions 159 include the ability to locate a line or range of lines based upon all or part of the content included therein. The interpretive instructions 159 may also include arithmetic functions to locate one or more lines in the source document 129 based upon location instructions previously executed. For example, the interpretive instructions 159 may locate an N^{th} line after a line that contains a string of predefined text.

In addition, all of the line location instructions in the interpretive instructions 159 may be applied to a range of lines. For example, a line in the source document 129 could be identified as containing predefined text within a range of lines in the source document 129. Also, the interpretive instructions 159 can calculate the end points of the range of lines using appropriate line location instructions. Once a range of lines in the source document 129 has been located, then it can be processed to form the output document 133. The interpretive instructions 159 may include instructions to perform textual transformations such as, for example, replacing, deleting, or inserting strings of text, or, altering the case of characters of text, etc.

Also, the interpretive instructions 159 may include a macro that is normally ignored until called by an appropriate “use” instruction. Such “use” instructions may be located, for example, in the prototype transform 123 and are implemented in the interpretive transform 126. Also, the macro may be located in the prototype transform 123, such a macro including transformation specific instructions. Such a macro may be useful for repetitive functions where the “use” instruction may be repeated several times in either the prototype transform 123, thereby eliminating repetition of the set of instructions contained in the macro itself. The “use” instruction may be recursive in that it may be repeated within the macro itself referencing the same or a different macro.

Alternatively, in box 203 a merger function may be performed where the interpretive transform 123 and the prototype transform 126 are employed to perform a merge function in which the output document 133 is generated from two or more source documents 129. In such case, an association is drawn between at least one prototype transform 123, an interpretive transform 126, and two or more source documents 129 that are applied to the transformation processor 119 to generate a corresponding output document 133. Such a prototype transform 123 would include interpreted instructions 156 dedicated to comparing and merging elements and/or attributes from the source documents 129 into the output document 133. In this context, the prototype transform 123 would include transformation specific instructions relating to the merger to be performed and the interpretive transform 126 would include corresponding transformation generic instructions.

In this respect, the interpretive instructions 159 may include, for example, instructions to compare element names, to observe or ignore character case when comparing element names, and to consider or not consider the level of nesting of elements during comparisons. Such instructions may also include instructions to use one or another matching elements from separate source documents 129 in the corresponding output document 133. Alternatively, two or more elements from separate source documents 129 may be merged using attributes from any one of the source documents 129. Also, attributes from multiple source documents 129 for respective merged elements may be combined in the output document 133. Also, the interpretive instructions may include criteria to be followed in merging attributes from separate source documents 129 when one or more such values differ. In addition, many other types of instructions may be included in the prototype transform 123 and the interpretive transform 126 relative to a merger function.

Once the current node or element from the prototype transform 123 has been processed in box 213, then the recursive routine 119a proceeds to box 216 in which it is determined whether there are further nodes in the prototype transform 123 to process or be interpreted accordingly. If such is the case, then in box 219 the recursive routine 119a is executed for the next node in the prototype transform 123. Otherwise, the recursive routine 119a ends accordingly. After the execution of the recursive routine 119a in box 219, then the recursive routine 119a also ends as shown.

Although the recursive routine 119a is embodied in software or code executed by general purpose hardware as discussed above, as an alternative the recursive routine 119a may also be embodied in dedicated hardware or a combination of software/general purpose hardware and dedicated hardware. If embodied in dedicated hardware, the recursive routine 119a can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIG. 5 shows the architecture, functionality, and operation of an implementation of a portion of the recursive routine 119a in performing a transformation via interpretation as described herein. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention. Also, the flow chart of FIG. 5 is relatively self-explanatory and is understood by those with ordinary skill in the art to the extent that software and/or hardware can be created by one with ordinary skill in the art to carry out the various logical functions as described herein.

Also, where the recursive routine 119a is implemented as software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the recursive routine 119a for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

[image]

[image]

[image]

[image]

[image]

[image]

[image]

[image]

[image]

[image]

[image]

[image]

[image]

[image]

[image]

[image]

[image]

[image]

[image]

[image]

[image]

I/We claim:

1. A transformation method, comprising:
providing a transformation processor;
providing a prototype transform and an interpretive transform; and
transforming at least one source document into an output document with the transformation processor by interpreting a number of interpreted instructions in the prototype transform with a number of interpretive instructions from the interpretive transform.

2. The method of claim 1, wherein the step of transforming the at least one source document into the output document with the transformation processor by interpreting the interpreted instructions in the prototype transform with the interpretive instructions from the interpretive transform further comprises processing a number of transformation specific instructions in the prototype transform, where the interpretive instructions are transformation generic.

3. The method of claim 1, further comprising drawing an association among the prototype transform, the interpretive transform, and the at least one source document.

4. The method of claim 3, wherein the step of drawing the association among the prototype transform, the interpretive transform, and the at least one source document further comprises providing a processing command to transform the at least one source document into the output document, the processing command to be applied to the transformation processor, the processing command referencing the prototype transform, the interpretive transform, and the at least one source document.

5. The method of claim 1, wherein the step of transforming the at least one source document into the output document with the transformation processor by interpreting the interpreted instructions in the prototype transform with the interpretive instructions from the interpretive transform further comprises applying the interpretive instructions to each element of the prototype transform.

6. The method of claim 1, wherein the step of transforming the at least one source document into the output document with the transformation processor by interpreting the interpreted instructions in the prototype transform with the interpretive instructions from the interpretive transform further comprises generating a portion of the output document based upon a direct element in the prototype transform.

7. The method of claim 5, wherein the step of applying the interpretive instructions to each element of the prototype transform further comprises:
detecting a match between an element in the prototype transform and a template embodied in the interpretive instructions; and
processing the element with the template to transform at least one source element in the at least one source document into a portion of the output document.

8. The method of claim 7, wherein the step of processing the element with the template to transform the at least one source element in the at least one source document into the portion of the output document further comprises writing a literal value included in the interpreted instructions into the output document.

9. The method of claim 7, wherein the step of processing the element with the template to transform at least one source element in the at least one source document into the portion of the output document further comprises writing attributes to the portion of the output document.

10. A computer program embodied in a computer readable medium to perform a transformation, comprising:
an interpretive transform;
a prototype transform to be interpreted using the interpretive transform;
at least one source document associated with the prototype transform;
a transformation processor; and
code that initiates a transformation of the at least one source document into an output document with the transformation processor, the transformation processor interpreting a number of interpreted instructions in the prototype transform with a number of interpretive instructions from the interpretive transform.

11. The computer program embodied in a computer readable medium of claim 10, wherein the interpretive instructions of the interpretive transform are transformation generic.

12. The computer program embodied in a computer readable medium of claim 10, wherein the interpreted instructions that are transformation specific.

13. The computer program embodied in a computer readable medium of claim 10, wherein the code that initiates a transformation of the at least one source document into an output document with the transformation processor further comprises code that applies a transformation command to the transformation processor, the command referencing the at least one source document, the prototype transform, and the interpretive transform.

14. A transformation system, comprising:
a processor circuit having a processor and a memory; and
transformation logic stored in the memory and executable by the processor, the transformation logic comprising:
an interpretive transform;
a prototype transform to be interpreted using the interpretive transform;
a transformation processor; and
logic that initiates a transformation of at least one source document into an output document with the transformation processor, the transformation processor interpreting a number of interpreted instructions in the prototype transform with a number of interpretive instructions from the interpretive transform, wherein an association is drawn between the at least one source document and the prototype transform.

15. The transformation system of claim 14, wherein the interpretive instructions of the interpretive transform are transformation generic.

16. The transformation system of claim 14, wherein the interpreted instructions of the prototype transform are transformation specific.

17. The transformation system of claim 14, wherein logic that initiates the transformation of the at least one source document into the output document with the transformation processor further comprises logic that applies a transformation command to the transformation processor, the command referencing the at least one source document, the prototype transform, and the interpretive transform.

18. A transformation system, comprising:
means for providing a number of interpreted instructions, the interpreted instructions being transformation specific;
means for providing a number of interpretive instructions, the interpretive instructions being transformation generic; and
means for transforming at least one source document into an output document by interpreting the interpreted instructions with the interpretive instructions with reference to the at least one source document.

19. The transformation system of claim 18, further comprises means for referencing the at least one source document, the prototype transform, and the interpretive transform to initiate a transformation of the at least one source document into an output document reference.
